(19) United States
(12) Patent Application Publication
(10) Pub. No.: US 2024/0389172 A1
(43) Pub. Date: Nov. 21, 2024

(54) DEVICE FOR TRANSMITTING PAIRING REQUEST INFORMATION TO HOST

(71) Applicant: Acrox Technologies Co., Ltd., Taipei (TW)

(72) Inventor: Chin-Sung Ho, Taipei (TW)

(21) Appl. No.: 18/537,199

(22) Filed: Dec. 12, 2023

(30) Foreign Application Priority Data
May 19, 2023 (TW) 112118812

(51) Int. Cl. H04W 76/14; H04L 5/00

(52) U.S. Cl. CPC H04W 76/14; H04L 5/0048

(57) ABSTRACT

In the present invention, a device for transmitting a pairing request information is provided. The device includes a memory having a field to store a pairing acknowledgement information, a transceiver, and a processor electrically connected to the memory and the transceiver. The processor is configured to determine whether the field is in one of conditions as follows: (1) the field is empty, (2) the field stores an information not being the pairing acknowledgement information, and (3) the field stores the pairing acknowledgement information that is not valid for the processor. The processor automatically drives the transceiver to transmit the pairing request information if the field is in the one condition.

### FIELD OF THE INVENTION

The present invention is related to a device for transmitting a pairing request information. More particularly, the present invention is related to a device for determining whether to transmit the pairing request information based on a field status of a field of a memory.

### BACKGROUND OF THE INVENTION

The user often uses the device (such as a mouse or keyboard) where the Bluetooth protocol is utilized to control a host that can be a computer. The housing of the device that utilizes the Bluetooth protocol is often provided with a pairing button. After the user presses the pairing button to be successfully paired with the host, the device can utilize the Bluetooth protocol to control the host.

### SUMMARY OF THE INVENTION

It is a first aspect of the present invention to provide a device for transmitting a pairing request information to a host. The device comprises a circuit, a switch, and a power source. The circuit includes a memory, a transceiver, and a processor. The memory has a field which includes a field status, the processor is electrically connected to the memory and the transceiver, and the power source is electrically connected to the circuit and the switch. Therefore, when the power source is turned on through the switch to provide a power to the processor of the circuit, the processor can be configured to execute a procedure of determining whether to automatically transmit the pairing request information based on the field status of the field.

It is a second aspect of the present invention to provide a device for transmitting a pairing request information. The device comprises a memory, a transceiver, and a processor. The memory includes a field for storing a pairing acknowledgement (ACK) information. Further, the processor is electrically connected to the memory and the transceiver, and configured to determine whether the field is in one of the following conditions: (1) the field is empty; (2) the field has stored an information that is not the pairing acknowledgement information; and (3) the field stores the pairing acknowledgement information that is not valid for the processor. If the processor determines that the field is in the one of the conditions (1)˜(3), the processor automatically drives the transceiver to transmit the pairing request information.

It is a third aspect of the present invention to provide a method of using a device for transmitting a pairing request information. The device includes a memory, a transceiver, and a processor. The memory has a field for storing a pairing acknowledgement information. The method comprises: determining, by the processor, whether the field stores the pairing acknowledgement information; and automatically driving, by the processor, the transceiver to transmit the pairing request information if determining, by the processor, that the field does not store the pairing acknowledgement information.

It is a fourth aspect of the present invention to provide a device for transmitting the pairing request information. The device comprises a memory, a transceiver, and a processor. The memory has a field for storing a pairing acknowledgement information. In addition, the processor is electrically connected to the memory and the transceiver, and configured to determine whether the field stores the pairing acknowledgement information. The processor automatically drives the transceiver to transmit the pairing request information if the processor determines that the field stores the pairing acknowledgement information and that the device is not successfully connected to the host corresponding to the pairing acknowledgement information.

The objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates the device for controlling a host according to one embodiment of the present invention.

FIG. 2 illustrates the process implemented by the device controlling the host according to one embodiment of the present invention.

FIG. 3 illustrates further explanations for specific procedures in FIG. 2.

FIG. 4 illustrates further explanations for specific procedures in FIG. 2.

FIG. 5 illustrates the method of using a device for transmitting the pairing request information according to one embodiment of the present invention.

### DETAILED DESCRIPTION OF THE PREFERRED EMBODIMENT

The present invention will now be described more specifically with reference to the following embodiments. It is to be noted that the following descriptions of the preferred embodiments of this invention are presented herein for the purposes of illustration and description only; they are not intended to be exhaustive or to be limited to the precise form disclosed.

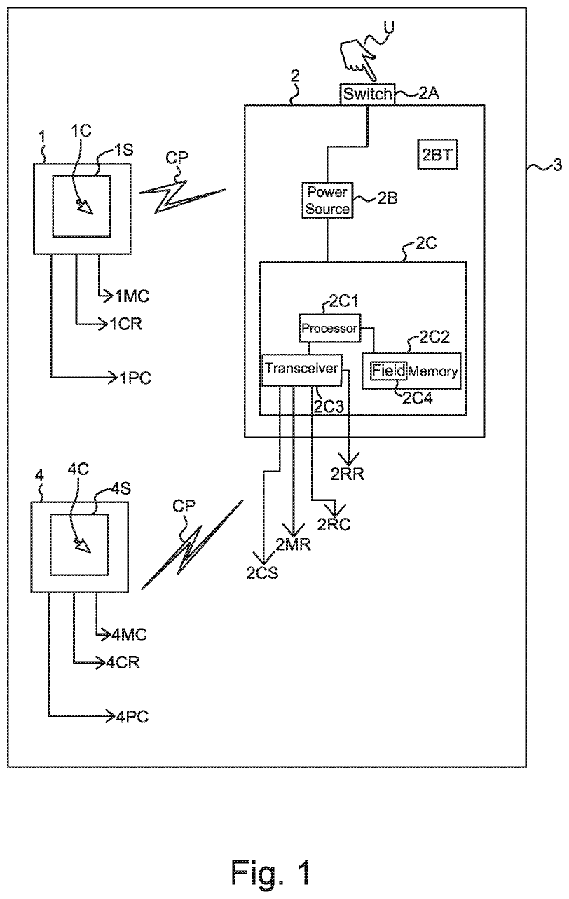

Please refer to FIG. 1 illustrating the device 2 that can control the host 1 or the host 4 in the environment 3 according to the embodiment of the present invention. In the environment where the device 2 is operated, one of the hosts 1 and 4 can be absent or there can be three or more hosts. However, for sufficient and concise descriptions hereinafter, the number of hosts in FIG. 1 is set at two. The host 1 has the screen 1S having the cursor 1C. In addition, the host 1 can transmit the paring acknowledgement information 1MC, the acknowledgement (ACK) connection signal 1CR, or the positive acknowledgement (ACK) signal 1PC. The host 4 has the screen 4S having the cursor 4C. In addition, the host 4 can transmit the pairing acknowledgement information 4MC, the acknowledgement connection signal 4CR, or the positive acknowledgement signal 4PC.

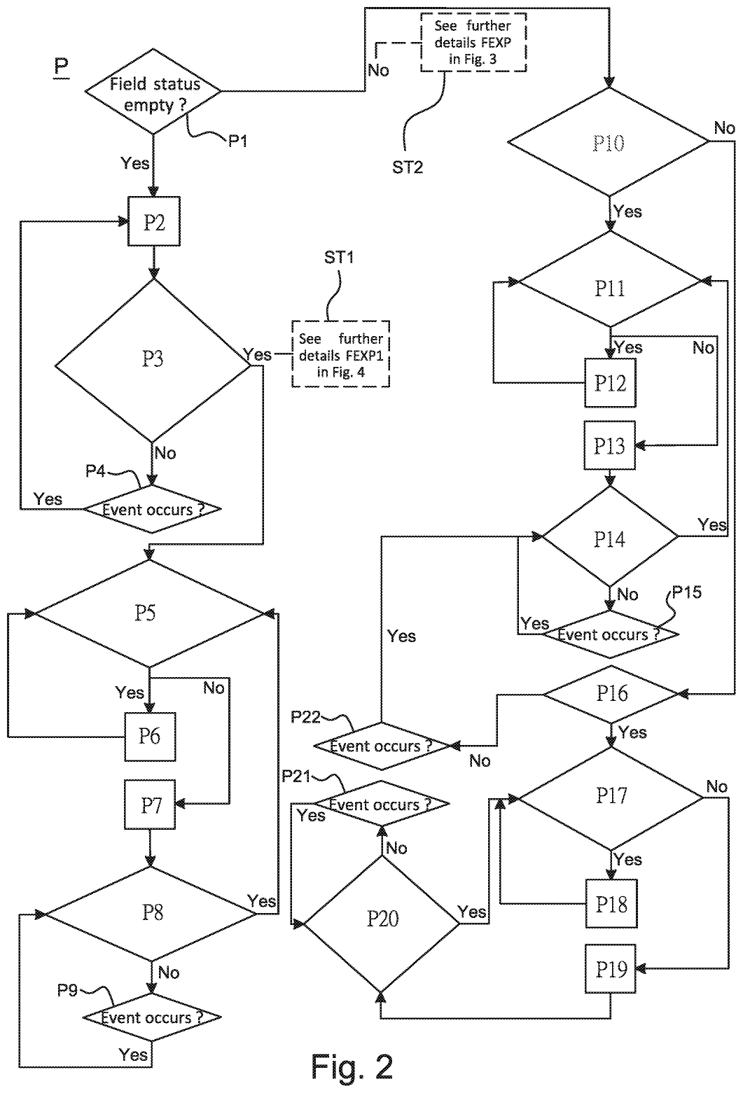

The device 2 can be, for example, a mouse or a keyboard. The device 2 has the circuit 2C, the switch 2A, the power source 2B, and the operation button 2BT. The operation button 2BT can be any one of the left button, right button, roller, and any other functional button of the mouse. The operation button 2BT can be any one of the keys of the keyboard. The circuit 2C has the processor 2C1, the memory 2C2, and the transceiver 2C3. The communication protocol CP between the device 2 and the host 1 and between the device 2 and the host 4 can be the Bluetooth communication protocol. Therefore, the transceiver 2C3 has the configuration of the the Bluetooth communication protocol. The memory 2C2 has the field 2C4 having a field status. The field status can be an empty status or a non-empty status. The processor 2C1 is electrically connected to the memory 2C2 and the transceiver 2C3. The processor 2C1 can drive the transceiver 2C3 to transmit a pairing request information 2MR, a requesting acknowledgement (ACK) signal 2RC, or a requesting connection signal 2RR. When the user U turns on the power source 2B through the switch 2A so that the power source 2B can provide a power to the processor 2C1 of the circuit 2C, the processor 2C1 is configured to execute a process P as shown in FIG. 2.

Please refer to FIG. 2, which illustrate the process P executed by the device 2 controlling the host 1 according to the embodiment of the present invention. The process P including the following Procedures P1˜P22 in FIG. 2 is explained as follows in conjunction with FIG. 1.

### The Procedure P1:

First of all, the processor 2C1 determines whether to automatically drive the transceiver 2C3 to transmit the pairing request information 2MR based on the field status of the field 2C4. Therefore, if the field status of the field 2C4 is the empty status, the processor 2C1 automatically executes the procedure P2. The empty status may be that, for example: the field 2C4 does not store any pairing acknowledgement information; the field 2C4 has stored an information that is not any pairing acknowledgement information; or the field 2C4 stores a pairing acknowledgement information that is not valid for the processor 2C1. The pairing acknowledgement information that is not valid for the processor 2C1 can be a pairing acknowledgement information based on the Zigbee communication protocol, but not based on the communication protocol CP as shown in FIG. 1.

If the field 2C4 has stored one of the pairing acknowledgement information 1MC and the pairing acknowledgement information 4MC of the hosts 1 and 4 so that the field status of the field 2C4 is the non-empty status, the processor 2C1 is configured to execute the procedure P10.

In the procedure P1, on the condition that the field status of the field 2C4 is the non-empty status, the stored one of the informations is defined as a pairing acknowledgement information STO, the one of the the hosts 1 and 4 that provides the stored pairing acknowledgement information STO is defined as a default host DE, and the other of the hosts 1 and 4 is defined as the non-default host NE.

Therefore, the default host DE can transmit the acknowledgement connection signal DEC, the pairing acknowledgement information STO or the positive acknowledgement signal DEP. Further, the default host DE has a screen DES which has a cursor DEU. The non-default host NE can transmit the acknowledgement connection signal NEC, the pairing acknowledgement information NEM or the positive acknowledgement signal NEP, and the non-default host NE has a screen NES which has a cursor NEU.

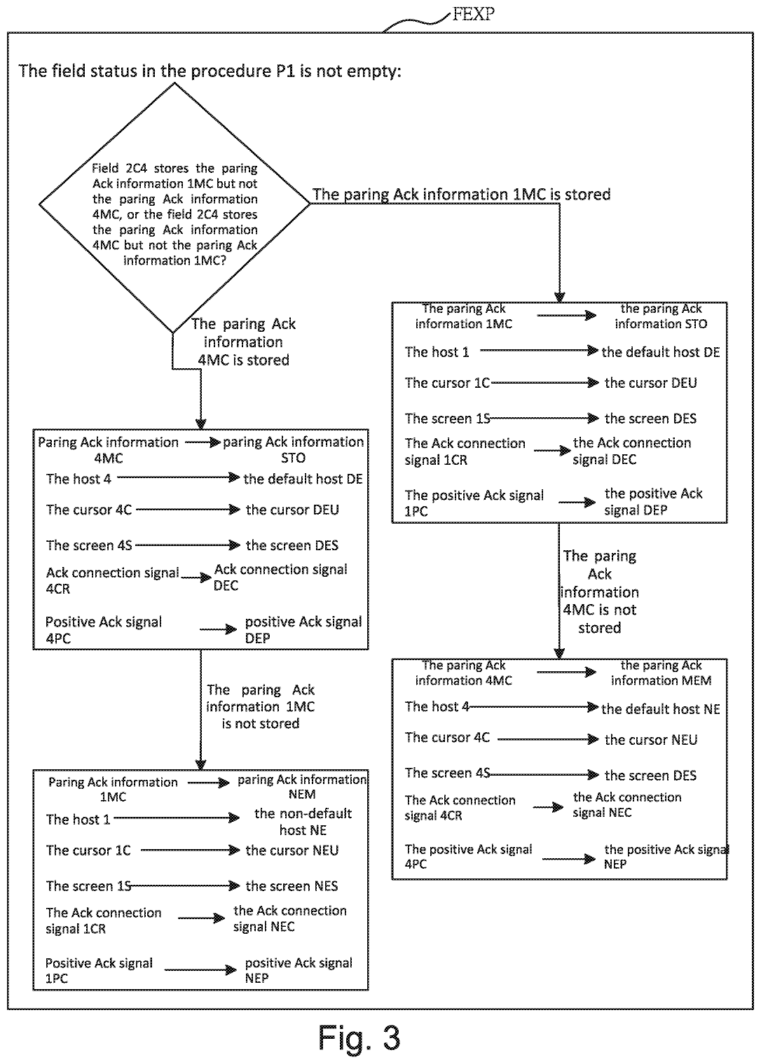

According to the further explanation FEXP in FIG. 3, it can be seen that in the procedure P1, on the condition that the field status of the field 2C4 is a non-empty status, if the field 2C4 stores the pairing acknowledgement information 1MC of the host 1, the pairing acknowledgement information 1MC serves as a pairing acknowledgement information STO, the host 1 serves as the default host DE, and the cursor 1C, the screen 1S, the acknowledgement connection signal 1CR, and the positive acknowledgement signal 1PC serve as the cursor DEU, the screen DES, the acknowledgement connection signal DEC, and the positive acknowledgement signal DEP, respectively. Therefore, in the procedure P1, if the pairing acknowledgement information 4MC of the host 4 is not stored in the field 2C4 so that the host 4 serves as the non-default host NE, the cursor 4C, the screen 4S, the pairing acknowledgement information 4MC, the acknowledgement connection signal 4CR, and the positive acknowledgement signal 4PC serve as the cursor NEU, the screen NES, the pairing acknowledgement information NEM, acknowledgement connection signal NEC, and the positive acknowledgement signal NEP, respectively.

In the procedure P1, if the field 2C4 stores the pairing acknowledgement information 4MC of the host 4, the pairing acknowledgement information 4MC serves as the pairing acknowledgement information STO, the host 4 serves as the default host DE, and the cursor 4C, the screen 4S, the pairing acknowledgement information 4MC, the acknowledgement connection signal 4CR, and the positive acknowledgement signal 4PC serve as the cursor DEU, the screen DES, the pairing acknowledgement information DES, acknowledgement connection signal DEC, and the positive acknowledgement signal DEP, respectively. Therefore, in the procedure P1, if the pairing acknowledgement information 1MC of the host 1 is not stored in the field 2C4 so that the host 1 serves as the non-default host NE, the cursor 1C, the screen 1S, the pairing acknowledgement information 1MC, the acknowledgement connection signal 1CR, and the positive acknowledgement signal 1PC serve as the cursor NEU, the screen NES, the pairing acknowledgement information NEM, acknowledgement connection signal NEC, and the positive acknowledgement signal NEP, respectively.

### The Procedure P2:

The processor 2C1 drives the transceiver 2C3 to transmit the pairing request information 2MR to the hosts 1 and 4, and after transmitting the pairing request information 2MR, the processor 2C1 is configured to execute the procedure P3.

### The Procedure P3:

If the transceiver 2C3 receives one of the pairing acknowledgement information 1MC transmitted from the host 1 in response to the pairing request information 2MR and the pairing acknowledgement information 4MC transmitted from the host 4 in response to the pairing request information 2MR (in this case, the one received by the transceiver 2C3 is defined as a pairing acknowledgement information REC, and the host selected from the hosts 1 and 4 and transmitting the pairing acknowledgement information REC is defined as the responding host RH) within a first default period (which is preferably 1 minute, and can be more or less than 1 minute), the processor 2C1 stores the received pairing acknowledgement information REC into the field 2C4 so that the device 2 and the responding host RH are successfully connected to each other and that the field status of the field 2C4 is the non-empty status. In addition, the processor 2C1 is configured to execute the procedure P5 within a second default period (which is preferably 30 ms, and can be more or less than 30 ms) after the device 2 and the responding host RH are successfully connected to each other. If the transceiver 2C3 does not receive any one of the pairing acknowledgement informations 1MC and 4MC within the first default period after the pairing request information 2MR is transmitted, the processor 2C1 drives the device 2 to enter a sleep mode and executes the procedure P4. In addition, the responding host RH can transmit the acknowledgement connection signal RHR, or positive acknowledgement signal RHP and has a screen RS which includes the cursor RHC.

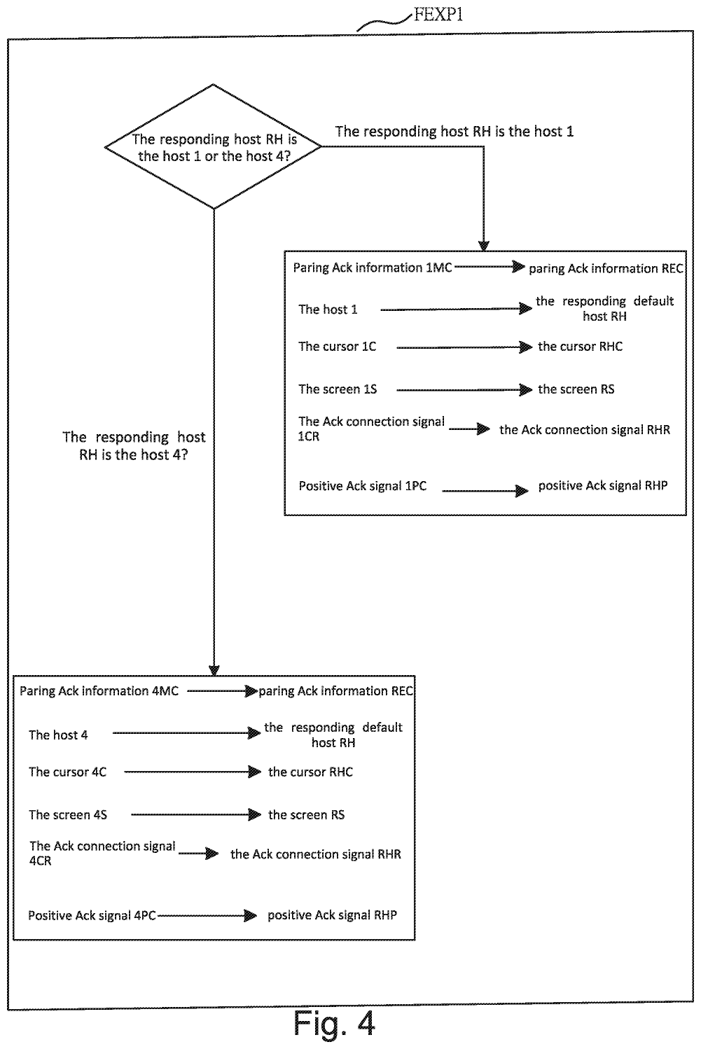

According to the further explanation FEXP1 in FIG. 4, it can be seen that in the procedure P3, if the host 1 serves as the responding host RH, the cursor 1C, the screen 1S, the pairing acknowledgement information 1MC, the acknowledgement connection signal 1CR, and the positive acknowledgement signal 1PC serve as the cursor RHC, the screen RS, the pairing acknowledgement information REC, the acknowledgement connection signal RHR, and the positive acknowledgement signal RHP, respectively. If the host 4 serves as the responding host RH, the cursor 4C, the screen 4S, the pairing acknowledgement information 4MC, the acknowledgement connection signal 4CR, and the positive acknowledgement signal 4PC serve as the cursor RHC, the screen RS, the pairing acknowledgement information REC, the acknowledgement connection signal RHR, and the positive acknowledgement signal RHP, respectively.

### The Procedure P4:

If one of an event that the operation button 2BT is operated and an event that the device 2 is moved occurs, the processor 2C1 drives the device 2 in the sleep mode to exit the sleep mode and executes the procedure P2, and if neither of the events occurs, the processor 2C1 keeps the device 2 in the sleep mode.

### The Procedure P5:

The processor 2C1 drives the transceiver 2C3 to transmit the requesting acknowledgement signal 2RC to the responding host RH to request the responding host RH to return the positive acknowledgement signal RHP. If the transceiver 2C3 receives the positive acknowledgement signal RHP within a third default period (which is preferably 30 ms, and can be more or less than 30 ms) after transmitting the requesting acknowledgement signal 2RC to the responding host RH, the processor 2C1 determines that the successful connection between the responding host RH and the device 2 remains and executes the procedure P6. If the transceiver 2C3 does not receive the positive acknowledgement signal RHP within the third default period, the processor 2C1 is configured to execute the procedure P7.

### The Procedure P6:

If the one event occurs within a fourth default period after determining that the successful connection between the responding host RH and the device 2 remains, the processor 2C1 drives the transceiver 2C3 to transmit a control signal CS based on the one event to the responding host RH to control the cursor RHC of the screen RS of the responding host RH. In addition, the processor 2C1 is configured to execute the procedure P5 after the fourth default period. Based on the design requirements, the fourth default period can be set as, e.g. several hours, several minutes, or several seconds.

### The Procedure P7:

On the condition that the transceiver 2C3 does not receive the positive acknowledgement signal RHP within the third default period, the processor determines that the responding host RH is not successfully connected and executes the procedure P8.

### The Procedure P8:

The processor 2C1 drives the transceiver 2C3 to transmit the requesting connection signal 2RR to the responding host RH. If the transceiver 2C3 receives the acknowledgement connection signal RHR transmitted by the responding host RH in response to the requesting connection signal 2RR within a fifth default period (which is preferably 10 seconds, and can be more or less than 10 seconds) after transmitting the requesting connection signal 2RR to the responding host RH, the processor 2C1 determines that the responding host RH is successfully connected, and executes the procedure P5 after the second default period following the successful connection between the device 2 and the responding host RH. If the transceiver 2C3 does not receive the acknowledgement connection signal RHR transmitted by the responding host RH in response to the requesting connection signal 2RR within the fifth default period, the processor 2C1 executes the procedure P9.

### The Procedure P9:

The processor drives the device 2 to enter the sleep mode. If the one event occurs in the sleep mode, the processor 2C1 executes the procedure P8. If the one event does not occur in the sleep mode, the processor 2C1 keeps the device 2 in the sleep mode.

### The Procedure P10:

The processor 2C3 transmits the requesting connection signal 2RR to the default host DE. If the transceiver 2C3 receives the acknowledgement connection signal DEC transmitted by the default host DE in response to the requesting connection signal 2RR within the fifth default period, the processor 2C1 determines that the device 2 and the default host DE are successfully connected to each other.

In addition, the processor executes the procedure P11 after the second default period following the successful connection between the device 2 and the default host DE.

If the transceiver 2C3 does not receive the acknowledgement connection signal DEC transmitted by the default host DE in response to the requesting connection signal 2RR within the fifth default period, the processor 2C1 is configured to execute the procedure P16.

### The Procedure P11:

The processor 2C1 drives the transceiver 2C3 to transmit the requesting acknowledgement signal 2RC to the default host DE to request the default host DE to return the positive acknowledgement signal DEP. If the transceiver 2C3 receives the positive acknowledgement signal DEP within the third default period following the transmission of the requesting acknowledgement signal 2RC, the processor 2C1 determines that the successful connection between the default host DE and the device 2 remains and executes the procedure P12. If the transceiver 2C3 does not receive the positive acknowledgement signal DEP within the third default period, the processor 2C1 is configured to execute the procedure P13.

### The Procedure P12:

If the one event occurs within the fourth default period after the processor 2C1 determines that the successful connection between the device 2 and the default host DE remains, the processor 2C1 drives the transceiver 2C3 to transmit the control signal CS based on the one event to the default host DE to control the cursor DEU, and executes the procedure P11 after the fourth default period.

### The Procedure P13:

The processor 2C1 determines that the default host DE is not successfully connected and executes the procedure P14.

### The Procedure P14:

The processor 2C1 drives the transceiver 2C3 to transmit the requesting connection signal 2RR to the default host DE. If the transceiver 2C3 receives the acknowledgement connection signal DEC transmitted by the default host DE within the fifth default period after transmitting the requesting connection signal 2RR, the processor 2C1 determines that the default host DE is successfully connected to the device 2, and executes the procedure P11 after the second default period following the successful connection between the default host DE and the device 2.

In addition, if the transceiver 2C3 does not receive the acknowledgement connection signal DEC transmitted by the default host DE within the fifth default period after transmitting the requesting connection signal 2RR, the processor 2C1 executes the procedure P15.

### The Procedure P15:

The processor 2C1 drives the device 2 to enter the sleep mode. The processor executes the procedure P14 if the one event occurs in the sleep mode. The processor 2C1 keeps the device 2 in the sleep mode if neither of the events occurs.

### The Procedure P16:

The processor 2C1 transmits the pairing request information 2MR to the non-default host NE. If the transceiver 2C3 receives the pairing acknowledgement information NEM transmitted from the non-default host NE in response to the pairing request information 2MR within the first default period after transmitting the pairing request information 2MR, the processor 2C1 replaces the pairing acknowledgement information STO in the field 2C4 of the memory 2C2 with the pairing acknowledgement information NEM so that the field status is the non-empty status and that the device 2 and the non-default host NE are successfully connected to each other. The processor 2C1 is configured to execute the procedure P17 after the second default period following the successful connection between the device 2 and the non-default host NE. If the transceiver 2C3 does not receive the pairing acknowledgement information NEM transmitted from the non-default host NE within the first default period after transmitting the pairing request information 2MR, the processor 2C1 is configured to execute the procedure P22.

### The Procedure P17:

The processor 2C1 drives the transceiver 2C3 to transmit the requesting acknowledgement signal 2RC to the non-default host NE to request the non-default host NE to return the positive acknowledgement signal NEP. If the transceiver 2C3 receives the positive acknowledgement signal NEP within the third default period after transmitting the requesting acknowledgement signal 2RC, the transceiver 2C3 determines that the successful connection between the device 2 and the non-default host NE remains, and executes the procedure P18. If the transceiver 2C3 does not receive the positive acknowledgement signal NEP within the third default period after transmitting the requesting acknowledgement signal 2RC, the processor 2C1 is configured to execute the procedure P19.

### The Procedure P18:

If the one event occurs within the fourth default period after determining that the successful connection between the device 2 and the non-default host NE remains, the processor 2C1 drives the transceiver 2C3 to transmit the control signal CS based on the one event to the non-default host NE to control the cursor NEU of the screen NES. The processor executes the procedure P17 after the fourth default period.

### The Procedure P19:

On the condition that the transceiver 2C3 does not receive the positive acknowledgement signal NEP within the third default period, the processor 2C1 determines that the non-default host NE is not successfully connected and executes the procedure P20.

### The Procedure P20:

The processor 2C1 drives the transceiver 2C3 to transmit the requesting connection signal 2RR to the non-default host NE. If the transceiver 2C3 receives the acknowledgement connection signal NEC transmitted by the non-default host NE within the fifth default period after transmitting the requesting connection signal 2RR, the processor 2C1 determines that the device 2 and the non-default host NE are successfully connected to each other, and executes the procedure P17 after the second default period following the successful connection between the non-default host NE and the device 2. If the transceiver 2C3 does not receive the acknowledgement connection signal NEC transmitted by the non-default host NE after transmitting the requesting connection signal 2RR within the fifth default period, the processor 2C1 executes the procedure P21.

### The Procedure P21:

The processor 2C1 drives the device 2 to enter the sleep mode. Then, if the one event occurs in the sleep mode, the processor 2C1 drives the device 2 to exit the sleep mode and executes the procedure P20. If the one event does not occur in the sleep mode, the processor 2C1 keeps the device 2 in the sleep mode.

### The Procedure P22:

The processor 2C1 drives the device 2 to enter the sleep mode. Then, if the one event occurs in the sleep mode, the processor 2C1 drives the device 2 to exit the sleep mode and executes the procedure P14. If the one event does not occur in the sleep mode, the processor 2C1 keeps the device 2 in the sleep mode.

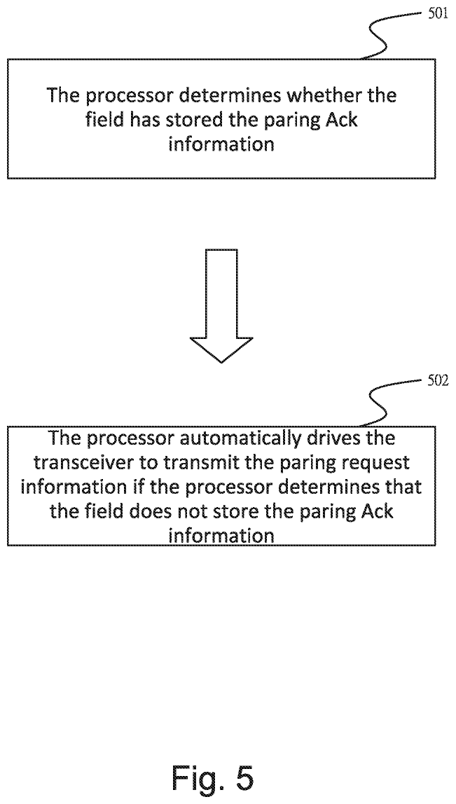

Please refer to FIG. 5 showing the method of using a device to transmit the pairing request information according to one embodiment of the present invention. The device has a memory, a transceiver, and a processor. The memory includes the field for storing the pairing request information. The method includes the steps 501 and 502. In the step 501, the processor determines whether the field stores the pairing request information. In the step 502, if the processor determines that the field does not store the pairing request information, the processor automatically drives the transceiver to transmit the pairing request information.

Based on the above, the present invention provides a device to control a host. Based on the field of the memory of the device, the processor of the device can determine whether to automatically transmit the pairing request information. Because the device can automatically transmit the pairing request information, the device does not need a physical pairing button. Therefore, the present invention not only provides the user with the operating convenience, but also simplifies the process of designing the casing of the device.

While the invention has been described in terms of what is presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device for transmitting a pairing request information to a host, comprising:
a circuit, having:
a memory having a field which includes a field status;
a transceiver; and
a processor electrically connected to the memory and the transceiver;
a switch; and
a power source electrically connected to the circuit and the switch, wherein when the power source is turned on through the switch to provide a power to the processor of the circuit, the processor is configured to execute a procedure of determining whether to automatically transmit the pairing request information based on the field status of the field.

2. The device as claimed in claim 1, wherein:
the device has an operation button, and the transceiver has a configuration based on a Bluetooth communication protocol, and the procedure is a first procedure;
in the first procedure, if the field status of the field is an empty status, the processor is configured to automatically execute a second procedure;
in the second procedure, the processor drives the transceiver to transmit the pairing request information to the host, and after transmitting the pairing request information, the processor is configured to execute a third procedure;
in the third procedure,
if the transceiver receives a pairing acknowledgement information transmitted from the host in response to the pairing request information within a default period after transmitting the pairing request information, the processor stores the pairing acknowledgement information into the field to make a successful connection between the device and the host and change the field status from the empty status to a non-empty status, and

3. The device as claimed in claim 2, wherein:
in the third procedure,
if the transceiver does not receive the pairing acknowledgement information transmitted from the host within the default period after transmitting the pairing request information, the processor drives the device to enter a sleep mode and executes a fourth procedure; and
in the fourth procedure,
if one of events where the operation button is operated and where the device is moved occurs, the processor drives the device to exit the sleep mode and executes the second procedure; and
if neither of the events occurs, the processor keeps the device in the sleep mode.

4. The device as claimed in claim 3, wherein:
the host has a screen showing a cursor; and
the device is a mouse, and the operation button is one of a left button, a right button, and a roller.

5. The device as claimed in claim 4, wherein:
the default period is a first default period;
in the third procedure, after a second default period following the successful connection between the device and the host, the processor executes a fifth procedure;
in the fifth procedure, the processor drives the transceiver to transmit a requesting acknowledgement signal to the host for requesting the host to return a positive acknowledgement signal, wherein if the transceiver receives the positive acknowledgement signal within a third default period, the processor determines that the successful connection remains, and executes a sixth procedure, and if the transceiver does not receive the positive acknowledgement signal within the third default period, the processor executes a seventh procedure;
in the sixth procedure:
if the one event occurs within a fourth default period after the processor determines that the successful connection remains, the processor drives the transceiver to transmit a control signal based on the one event to the host to control the cursor; and
the processor executes the fifth procedure after the fourth default period;
in the seventh procedure, the processor determines that there is an unsuccessful connection between the device and the host, and executes an eighth procedure; and
in the eighth procedure, the processor drives the transceiver to transmit a requesting connection signal to the host.

6. The device as claimed in claim 5, wherein:
in the eighth procedure:
if the transceiver receives an acknowledgement connection signal transmitted from the host in response to the requesting connection signal within a fifth default period, the processor determines that there is the successful connection between the device and the host, and executes the fifth procedure after the second default period following the successful connection, and
if the transceiver does not receive the acknowledgement connection signal transmitted from the host in response to the requesting connection signal within the fifth default period, the processor executes a ninth procedure; and
in the ninth procedure, the processor drives the device to enter the sleep mode, wherein in the sleep mode, if the one event occurs, the processor executes the eighth procedure; and if neither of the events occurs, the processor keeps the device in the sleep mode.

7. The device as claimed in claim 6, wherein the first default period is one minute or less, each of the second default period and the third default period is 30 milliseconds or less, and the fifth default period is 10 seconds or less.

8. The device as claimed in claim 7, wherein:
in the first procedure, if the field stores the pairing acknowledgement information of the host such that the field status is the non-empty status, the processor executes a tenth procedure; and
in the tenth procedure, the processor drives the transceiver to transmit the requesting connection signal to the host.

9. The device as claimed in claim 8, wherein:
in the tenth procedure, if the transceiver receives the acknowledgement connection signal transmitted from the host in response to the requesting connection signal within the fifth default period, the processor determines that there is the successful connection between the device and the host.

10. The device as claimed in claim 9, wherein:
the host is a first host of a plurality of hosts including a second host, the screen is a first screen, the cursor is a first cursor, the pairing acknowledgement information is a first pairing acknowledgement information, the positive acknowledgement signal is a first positive acknowledgement signal, and the acknowledgement connection signal is a first acknowledgement connection signal;
the second host has a second screen showing a second cursor, and is configured for transmitting a second pairing acknowledgement information, a second positive acknowledgement signal, and a second acknowledgement connection signal;
in the tenth procedure, after the second default period following the successful connection between the device and the first host, the processor executes an eleventh procedure; and
in the eleventh procedure, the processor drives the transceiver to transmit the requesting acknowledgement signal to the first host to request the first host to return the first positive acknowledgement signal.

11. The device as claimed in claim 10, wherein:
in the eleventh procedure, if the transceiver receives the first positive acknowledgement signal within the third default period, the processor determines that the successful connection between the device and the first host remains, and executes a twelfth procedure, and if the transceiver does not receive the first positive acknowledgement signal within the third default period, the processor executes a thirteenth procedure;
in the twelfth procedure, if the one event occurs within the fourth default period following the successful connection between the first host and the device, the processor drives the transceiver to transmit the control signal based on the one event to the first host to control the first cursor, and the processor executes the eleventh procedure after the fourth default period;
in the thirteenth procedure, the processor determines that there is the unsuccessful connection between the device and the first host, and executes a fourteenth procedure; and
in the fourteenth procedure, the processor drives the transceiver to transmit the requesting connection signal to the first host.

12. The device as claimed in claim 11, wherein:
in the fourteenth procedure, if the transceiver receives the first acknowledgement connection signal transmitted from the first host in response to the requesting connection signal within the fifth default period, the processor determines that the successful connection between the device and the first host remains, and executes the eleventh procedure after the second default period following the successful connection remaining between the device and the first host.

13. The device as claimed in claim 12, wherein:
in the tenth procedure, if the transceiver does not receive the first acknowledgement connection signal transmitted by the first host in response to the requesting connection signal within the fifth default period, the processor executes a sixteenth procedure;
in the fourteenth procedure, if the transceiver does not receive the first acknowledgement connection signal transmitted from the first host in response to the requesting connection signal within the fifth default period, the processor executes a fifteenth procedure;
in the fifteenth procedure, the processor drives the device to enter the sleep mode, wherein in the sleep mode, if the one event occurs, the processor executes the fourteenth procedure, and if neither of the events occurs, the processor keeps the device in the sleep mode; and
in the sixteenth procedure, the processor transmits the pairing request information to the second host.

14. The device as claimed in claim 13, wherein:
in the sixteenth procedure, if the transceiver receives the second pairing acknowledgement information transmitted from the second host in response to the pairing request information within the first default period after transmitting the pairing request information, the processor replaces the first pairing acknowledgement information in the field of the memory with the second pairing acknowledgement information to make a successful connection between the device and the second host such that the field status is still the non-empty status.

15. The device as claimed in claim 14, wherein:
in the sixteenth procedure:
after the second default period following the successful connection between the device and the second host, the processor executes a seventeenth procedure; and in the seventeenth procedure, the processor drives the transceiver to transmit a requesting acknowledgement signal to the second host for requesting the host to return the second positive acknowledgement signal.

16. The device as claimed in claim 15, wherein:
in the seventeenth procedure, if the transceiver receives the second positive acknowledgement signal within the third default period, the processor determines that the successful connection between the second host and the device remains, and executes an eighteenth procedure, and if the transceiver does not receive the second positive acknowledgement signal within the third default period, the processor executes a nineteenth procedure;
in the eighteenth procedure, if the one event occurs within the fourth default period after the processor determines that the successful connection between the device and the second host remains, the processor drives the transceiver to transmit the control signal based on the one event to the second host to control the second cursor, and the processor executes the seventeenth procedure after the fourth default period;
in the nineteenth procedure, the processor determines that there is an unsuccessful connection between the device and the second host, and executes a twentieth procedure; and
in the twentieth procedure, the processor drives the transceiver to transmit the requesting connection signal to the second host, wherein:
if the transceiver receives the second acknowledgement connection signal transmitted from the second host in response to the requesting connection signal within the fifth default period, the processor determines that there is the successful connection between the device and the second host, and executes the seventeenth procedure after the second default period following the successful connection between the second host and the device.

17. The device as claimed in claim 16, wherein:
in the sixteenth procedure:
if the transceiver does not receive the second pairing acknowledgement information transmitted from the second host in response to the pairing request information within the first default period after transmitting the pairing request information, the processor executes a twenty-second procedure;
in the twentieth procedure:
if the transceiver does not receive the second acknowledgement connection signal transmitted by the second host in response to the requesting connection signal within the fifth default period, the processor executes a twenty-first procedure;
in the twenty-first procedure, the processor drives the device to enter the sleep mode, wherein in the sleep mode, if the one event occurs, the processor executes the twentieth procedure, and if neither of the events occurs, the processor keeps the device in the sleep mode; and
in the twenty-second procedure, the processor drives the device to enter the sleep mode, wherein in the sleep mode, if the one event occurs, the processor executes the fourteenth procedure, and if neither of the events occurs, the processor keeps the device in the sleep mode.

18. A device for transmitting a pairing request information, the device comprising:
a memory having a field to store a pairing acknowledgement information;
a transceiver; and
a processor electrically connected to the memory and the transceiver, and configured to:
determine whether the field is in one of conditions as follows: (1) the field is empty, (2) the field stores an information not being the pairing acknowledgement information, and (3) the field stores the pairing acknowledgement information that is not valid for the processor; and
automatically drive the transceiver to transmit the pairing request information if the field is in the one condition.

19. The device as claimed in claim 18, wherein:
the pairing acknowledgement information is corresponding to a host; and
the processor is configured to:
determine whether the field stores the pairing acknowledgement information; and
automatically drive the transceiver to transmit the pairing request information if the processor determines that the field stores the pairing acknowledgement information and that the device is not successfully connected to the host.

20. A method of using a device for transmitting a pairing request information, wherein the device has a memory, a transceiver, and a processor, and the memory has a field for storing a pairing acknowledgement information, and the method comprises:
determining, by the processor, whether the field stores the pairing acknowledgement information; and
automatically driving, by the processor, the transceiver to transmit the pairing request information if determining, by the processor, that the field does not store the pairing acknowledgement information.
